(19) United States
(12) Patent Application Publication
(10) Pub. No.: US 2002/0178555 A1
(43) Pub. Date: Dec. 5, 2002

(54) Clip device for two flaps of boxes

(76) Inventor: Steven Tsai, Taichung city (TW)

Correspondence Address: DOUGHERTY & TROXELL, ONE SKYLINE PLACE, SUITE 1404, 5205 LEESBURG PIKE, FALLS CHURCH, VA, 22041, US

(21) Appl. No.: 09/873,325

(22) Filed: Jun. 5, 2001

(51) Int. Cl. F16B 5/00

(52) U.S. Cl. 24/572.1

(57) ABSTRACT

A clip device includes a first board with a T-shaped connection plate extending from a first surface thereof. The T-shaped connection plate includes a first plate extending vertically from the first surface of the first board and a second plate is connected on a top edge of the first plate. A second board has a groove defined in a first surface thereof and two receiving spaces are defined in the groove. The second plate is engaged with one of the two receiving spaces of the groove. Two flaps of a box are received in two sides of the clip device.

### FIELD OF THE INVENTION

The present invention relates to an I-shaped clip device having two side grooves for respectively receiving two flaps of a box.

### BACKGROUND OF THE INVENTION

A box made of paper boards generally includes two long-side flaps and two short-side flaps which are located below the two long-side flaps and a tape is used to connect the two long-side flaps together to seal the opening of the box. A clip device includes three layers and a connection plate is connected between the top two layers so as to define two side slots for receiving two flaps of box. The width of each of the two slots is fixed and cannot be adjustable, so that the clip can only fit with certain type of box wherein the thickness of the flaps is properly received in the slots. However, if the thickness of the flaps is thicker than the width of the slots, the flaps cannot be received in the slots. If the thickness of the flaps is too thin, the clip cannot properly hold the flaps.

The present invention intends to provide a clip device which slots can be adjusted to meet different thickness of the flaps of boxes.

### SUMMARY OF THE INVENTION

In accordance with one aspect of the present invention, there is provided a clip device which comprises a first board having a T-shaped connection plate extending from a first surface thereof and a second board is connected to the T-shaped connection plate. The T-shaped connection plate includes a first plate extending vertically from the first surface of the first board and a second plate is connected on a top edge of the first plate. A second board has a groove defined in a first surface thereof and two separation ridges respectively extend from two opposite insides of the groove so as to define two receiving spaces. The second plate is engaged with one of the two receiving spaces.

The primary object of the present invention is to provide a clip device that has two side slots for receiving two flaps of boxes, wherein the width of opening of the two side slots can be adjusted.

The present invention will become more obvious from the following description when taken in connection with the accompanying drawings which show, for purposes of illustration only, multiple preferred embodiments in accordance with the present invention.

### BRIEF DESCRIPTION OF THE DRAWINGS

FIG. 1 is a perspective view to show the clip device of the present invention;

FIG. 2 is an exploded view to show the clip device of the present invention;

FIG. 3 is a perspective view to show the clip device is engaged with two flaps of a box;

FIG. 4 is a cross sectional view to show that two flaps of the box are received in two side slots of the clip device of the present invention;

FIG. 5 is an end cross sectional view to show the second plate of the T-shaped connection plate is engaged with one of the two receiving spaces in the second board;

FIG. 6 is a perspective view to show the first board and the second board of the clip device respectively have two recesses on two sides thereof;

FIG. 7 is a top view to show the clip device as shown in FIG. 6;

FIG. 8 is an end cross sectional view to show another embodiment of the clip device of the present invention;

FIG. 9 is an end cross sectional view to show yet another embodiment of the clip device of the present invention, and

FIG. 10 is an end cross sectional view to show another embodiment of the clip device of the present invention.

### DETAILED DESCRIPTION OF THE PREFERRED EMBODIMENTS

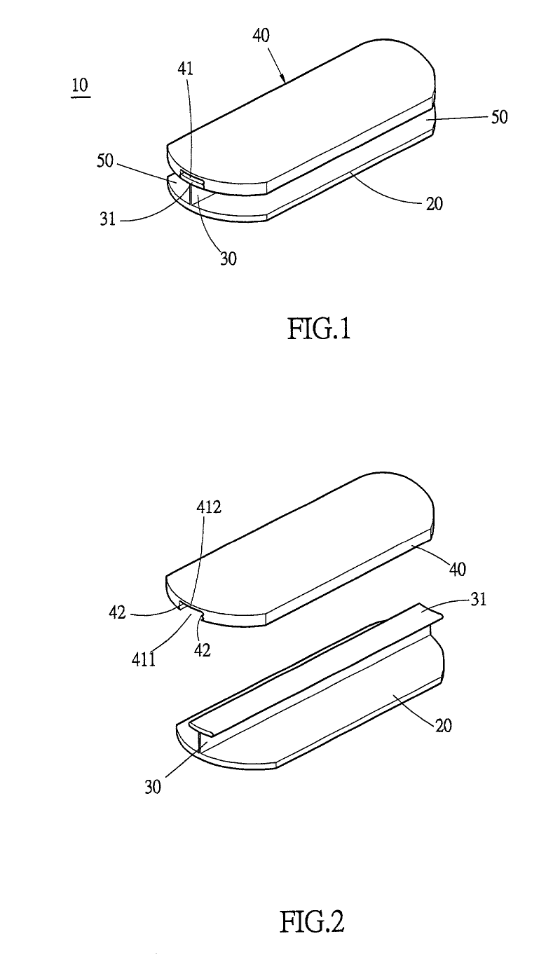

Referring to FIGS. 1 and 2, the clip device 10 of the present invention comprises a first board 20 having a T-shaped connection plate extending from a first surface thereof and a second board 40 is connected to the T-shaped connection plate. The T-shaped connection plate includes a first plate 30 extending vertically from a central axis of the first surface of the first board 20 and a second plate 31 is connected on a top edge of the first plate 30 so as to form the T-shaped structure.

The second board 40 has a groove 41 defined in a first surface thereof and two separation ridges 42 respectively extend from two opposite insides of the groove 41 so as to define two receiving spaces 411, 412 in the groove 41 by the separation ridges 42. The second plate 31 can be engaged with one of the two receiving spaces 411, 412 and two side slots 50 are respective defined in two lateral sides of the clip device 10.

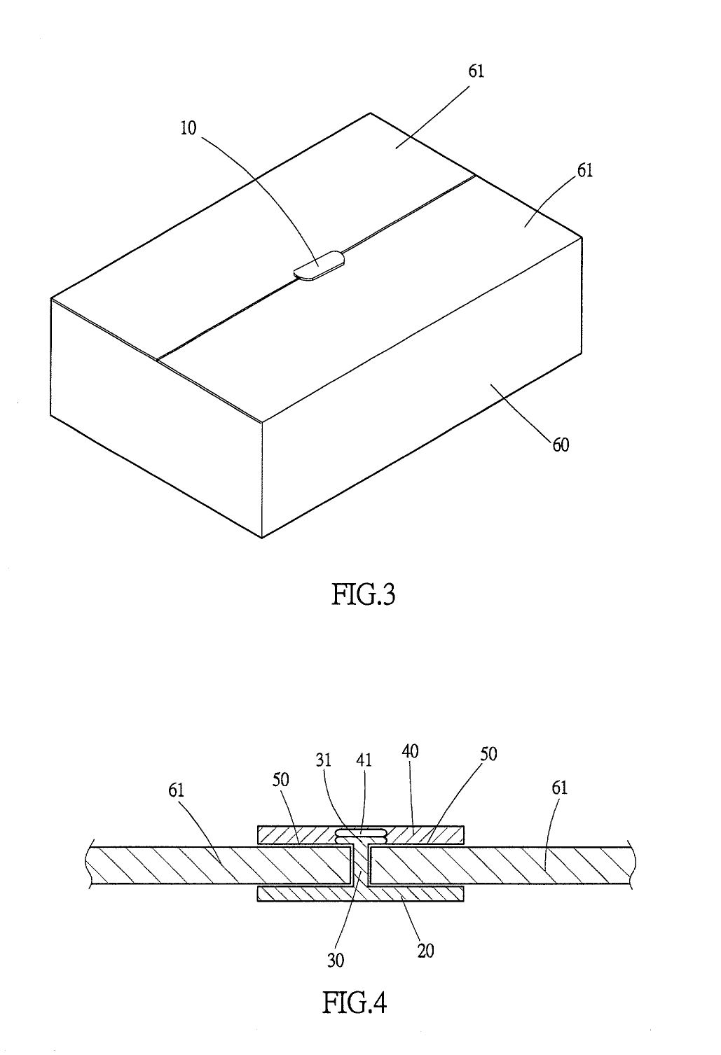

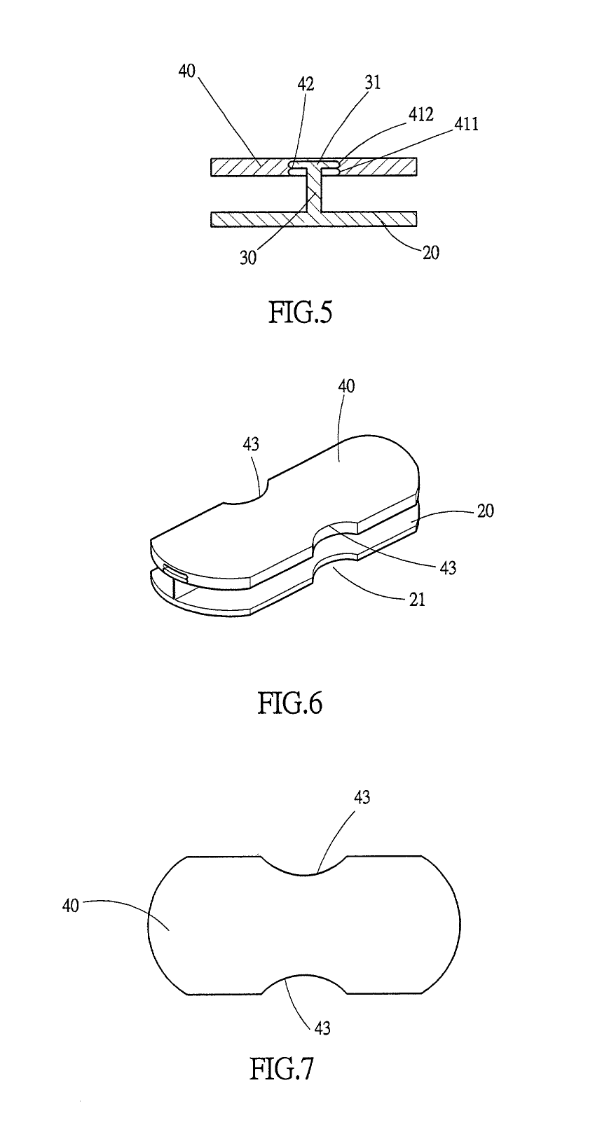

As shown in FIGS. 3 and 4, two flaps 61 of a box 60 are respectively slid into the two side slots 50 of the clip device 10 and the clip device 10 can be slid to a desired position of the box 60. The second plate 31 can be received in the receiving space 412 so as to narrow the width of the side slots 50 as shown in FIG. 5 such that thin flaps can also be properly received in the side slots 50.

As shown in FIGS. 6 and 7, the first board 20 and the second board 40 each have two recesses 21/43 defined in two sides thereof so that the user's fingers are conveniently engaged with these recesses 21, 43 to move the clip device 10.

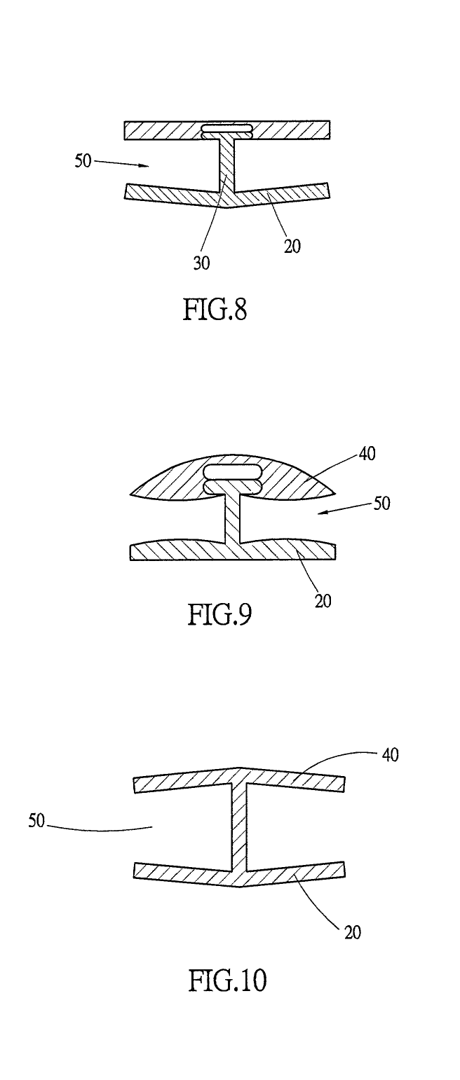

As shown in FIGS. 8, the first surface of the first board 20 includes two inclined surfaces which are separated by the T-shaped connection plate. By the inclined surfaces, the opening of the two side slots 50 are narrower and may hold the flaps securely. As shown in FIG. 9, the first surface of the first board 20 includes two convex surfaces which are separated by the T-shaped connection plate. The first surface of the second board 40 includes two convex surfaces which are separated by the groove 41. By the convex surfaces, the mediate portion of the side slots 50 are narrowed to clip the flaps. FIG. 10 shows that the first board 20 and the second board 40 each have two inclined surfaces so that the side slots 50 have a narrow opening.

While we have shown and described the embodiments in accordance with the present invention, it should be clear to those skilled in the art that further embodiments may be made without departing from the scope of the present invention.

What is claimed is:

1. A clip device comprising:
a first board having a T-shaped connection plate extending from a first surface thereof, said T-shaped connection plate including a first plate extending vertically from said first surface of said first board and a second plate connected on a top edge of said first plate, and
a second board having a groove defined in a first surface thereof and two separation ridges respectively extending from two opposite insides of said groove, two receiving spaces defined in said groove by said separation ridges, said second plate engaged with one of said two receiving spaces.

2. The clip device as claimed in claim 1, wherein said first board has two recesses defined in two sides thereof.

3. The clip device as claimed in claim 1, wherein said first board has two recesses defined in two sides thereof.

4. The clip device as claimed in claim 1, wherein said first surface of said first board includes two inclined surfaces which are separated by said T-shaped connection plate.

5. The clip device as claimed in claim 1, wherein said first surface of said second board includes two inclined surfaces which are separated by said groove.

6. The clip device as claimed in claim 1, wherein said first surface of said first board includes two convex surfaces which are separated by said T-shaped connection plate.

7. The clip device as claimed in claim 1, wherein said first surface of said second board includes two convex surfaces which are separated by said groove.
